(19) United States
(12) Patent Application Publication
(10) Pub. No.: US 2015/0343982 A1
(43) Pub. Date: Dec. 3, 2015

(54) AIRBAG MODULE FOR A MOTOR VEHICLE

(71) Applicant: TAKATA AG, Aschaffenburg (DE)

(72) Inventors: Tobias FECHNER, Aschaffenburg (DE); Andre BUCHHOLZ, Berlin (DE); Peter WEIS, Dammbach (DE)

(73) Assignee: TAKATA AG, Aschaffenburg, (DE)

(21) Appl. No.: 14/761,535

(22) PCT Filed: Feb. 18, 2014
(86) PCT No.: PCT/EP2014/053129

§ 371 Date: Jul. 16, 2015

(30) Foreign Application Priority Data
Feb. 21, 2013 (DE) 10 2013 202 846.6

(51) Int. Cl. B60R 21/217; B60R 21/276

(52) U.S. Cl. CPC B60R 21/217; B60R 21/276; B60R 2021/2765

(57) ABSTRACT

An airbag module for a motor vehicle is provided. The airbag module comprises a gas bag which for the protection of a person can be inflated by means of a gas generator, a module housing for accommodating the gas bag, which includes a tab which protrudes from a main chamber of the module housing accommodating the gas bag, a gas bag holder for fixing the gas bag at the module housing, an inflatable element for regulating the gas pressure in the gas bag, a triggering unit for filling the inflatable element with gas, which is arranged within the module housing in the tab of the module housing, and a fixing element by means of which the triggering unit is fixed at the module housing. The fixing element with a base body, with which it at least partly encloses the triggering unit, engages into the tab of the module housing.

### CROSS-REFERENCE TO A RELATED APPLICATION

This application is a National Phase Patent Application of International Patent Application Number PCT/EP2014/053129, filed on Feb. 18, 2014, which claims priority of German Patent Application Number 10 2013 202 846.6, filed on Feb. 21, 2013.

### BACKGROUND

This invention relates to an airbag module for a motor vehicle.

Such airbag module comprises a gas bag which for the protection of a person, in particular a vehicle occupant, can be inflated by means of a gas generator, and a module housing for accommodating the gas bag, and a gas bag holder for fixing the gas bag at the module housing, which usually is connected with the latter, e.g. via at least one screw.

Furthermore, the airbag module regularly includes a vent opening through which gas originating from the airbag module, which was released by the gas generator for inflating the gas bag, can escape from the airbag module, wherein for regulating the gas pressure in the gas bag the outlet cross-section of the vent opening is controllable. For this purpose an inflatable element (different from the gas bag) is provided, which is fixed at the gas bag holder and which in the inflated condition interacts with a vent opening of the airbag module, in order to be able to control, i.e. in particular vary, its outlet cross-section.

A triggering unit (different from the gas generator serving for inflating the gas bag), via which the inflatable element can be filled with gas, e.g. in a sensor-controlled manner, is associated to the inflatable element, in order to accomplish a desired control or variation of the outlet cross-section of the associated vent opening of the airbag module.

With such a device it is possible to selectively control the so-called venting of a gas bag, i.e. the draining of those gases which were released by a gas generator and introduced into the gas bag for the protection of a vehicle occupant, for example in dependence on the kind and severity of an accident and on the size and/or the weight and/or the seating position of a person to be protected, which can be detected in particular by means of sensors.

For selectively filling the inflatable element with a gas, in order to accomplish the desired regulation of the gas pressure in the gas bag or a desired control of the outlet cross-section of the associated vent opening, the triggering unit comprises a gas source, which for example can be ignited pyrotechnically and then releases a gas with which the inflatable element is filled, so that it interacts with said vent opening and controls (changes) its outlet cross-section.

According to one variant, the vent opening can originally be covered by a covering member, so that the control of the outlet cross-section by means of the inflatable element is effected such that the inflatable element effects an at least partial clearance of the vent opening, e.g. by corresponding action on the covering member. According to another variant, the vent opening originally can be exposed and only upon filling the inflatable element with gas can be covered at least in part. It is also possible that the vent opening initially is partly covered by a covering member and the degree of coverage is changed by action of the inflatable element.

An airbag module with such mechanism for regulating the gas pressure in the gas bag is known from WO 2011/157 631 A1. In the present case, reference fully is made to this document in particular with regard to the filling of the inflatable element with a gas and with regard to the interaction of the inflatable element with a vent opening of the airbag module.

According to WO 2011/157 631 A1, the triggering unit associated to the inflatable element is arranged below the bottom of the module housing and in the housing bottom an aperture is formed, through which the gases released by the triggering unit can be introduced into the inflatable element to be filled therewith.

### SUMMARY

It is a problem underlying the invention to further improve an airbag module as mentioned above.

According to the invention, this problem is solved by creating an airbag module with the features as described herein.

Accordingly, the triggering unit is arranged within the module housing in a projection of the module housing, which protrudes from a main chamber of the module housing accommodating the gas bag. The triggering unit can be fixed in the module housing or more exactly in its projection in a simple way by means of a fixing element e.g. made of plastics, in particular by means of exactly one single fixing element. For this purpose, the triggering unit can positively be connected with the fixing element, in particular such that the triggering unit supports on the fixing element on its outside, possibly also over the entire extension of the outside. The fixing element thus engages into the projection and there at least sectionally encloses the triggering unit.

On the one hand, the triggering unit thereby is protected against environmental influences and on the other hand the surroundings of the airbag module also are protected against actions of the triggering unit on ignition of the associated gas source.

The solution according to the invention seems to be faced with the difficulty that the module housing is occupied by the gas bag accommodated therein in a compressed or folded condition and therefore no space is available in the module housing for the arrangement of the triggering unit associated to the inflatable element.

It has been recognized, however, that in the present case an arrangement of the triggering unit in a projection of the module housing is technically possible and advantageous, which projection protrudes from the chamber (“main chamber”) of the module housing accommodating the folded gas bag and is integrally formed with the same. It can thereby be achieved that the triggering unit on the one hand is accommodated in a space defined (and protected) by the walls of the module housing, but at the same time can be accommodated separate from the gas bag provided in the module housing.

According to one embodiment, that projection is extended longitudinally (axially) and designed annular in cross-section, in particular formed around in a ring-shaped manner.

Concretely, the triggering unit can be held between the fixing element and a stop of the module housing, in particular a stop on a projection of the module housing which is provided for accommodating the triggering unit.

Furthermore, the fixing element (e.g. in the form of a fixing clip) can include at least one latching hook which is latchable at the module housing and/or the gas bag holder, in order to achieve the fixation of the triggering unit at the module housing; i.e. either a direct fixation or an indirect fixation via the gas bag holder connected with the module housing.

The arrangement can be designed such that in the latched condition the at least one latching hook of the fixing element is prevented from becoming unlatched by the triggering unit, in that the latching hook e.g. gets in contact with the triggering unit when it is deformed such that it might get out of engagement with the gas bag holder and a further deformation of the latching hook thereby is prevented.

In the case of an activation of the gas source associated to the triggering unit and a related (radial) expansion of the triggering unit, the latching hooks of the fixing element also can tend to be pushed away such that the connection between fixing element or latching hook on the one hand and gas bag holder on the other hand thereby even is reinforced.

The inflatable element to be filled with gas by means of the triggering unit, which can be designed e.g. as inflatable hose (“pressure hose”), advantageously is arranged within the associated gas bag; it can, however, also lie outside the gas bag.

The fixing element serving for fixation of the triggering unit in the module housing furthermore can also serve for fixing the inflatable element, in that e.g. the at least one latching hook and/or a head of the fixing element is provided for fixing the inflatable element at the gas bag holder.

The arrangement and fixation on the one hand of the triggering unit within the module housing and on the other hand of the inflatable element within the gas bag then can be effected by means of the gas bag holder and the fixing element in one step.

### BRIEF DESCRIPTION OF THE DRAWINGS

Further details and advantages of the invention will become apparent from the following description of an exemplary embodiment with reference to the Figures.

FIG. 1 shows a section of an airbag module which comprises a gas bag, a gas generator for inflating the gas bag and a module housing for accommodating the gas bag.

FIG. 2 shows a detail of the airbag module of FIG. 1 in the region of a fixing element via which an inflatable element provided for regulating the internal pressure of the gas bag and an associated triggering unit are fixed at the airbag module.

FIG. 3 shows a section of the bottom region of the module housing of FIG. 1.

### DETAILED DESCRIPTION

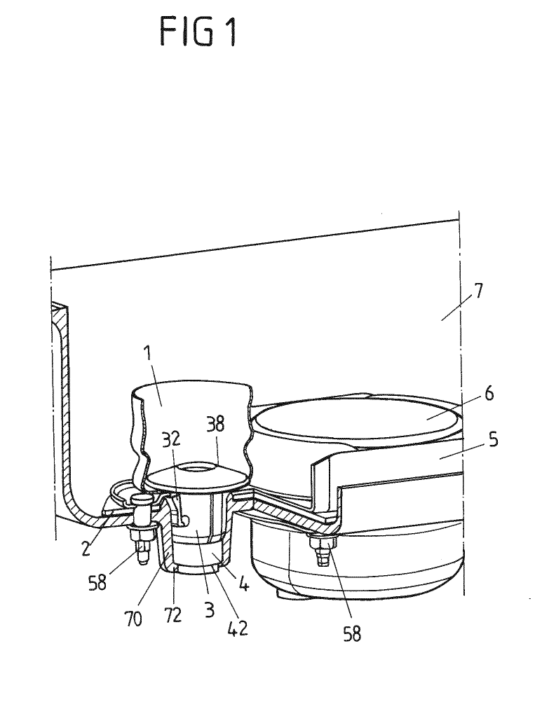

FIG. 1 shows a perspective representation of a section of an airbag module for a motor vehicle, which comprises a gas bag 2 arranged in a module housing 7, which is inflatable for the protection of a vehicle occupant, and a gas generator 6 arranged at the module housing 7 for inflating the gas bag 2. For fixing the gas bag 2 at the module housing 7 a gas bag holder 5, here in the form of a retaining plate, is provided, which by suitable fastening means 58, here in the form of screws and associated nuts, is attached to the module housing 7, more exactly to its bottom, wherein the gas bag 2 is clamped e.g. between the gas bag holder 5 and the module housing 7.

The gas bag 2 of such airbag module can be filled with gas by means of the gas generator 6, in general in a sensor-controlled manner, so that it exits from the module housing 7 and in the deployed, inflated condition forms a gas cushion for the protection of a vehicle occupant (or possibly also a person present outside the motor vehicle).

Depending on the kind and severity of the accident and in dependence on weight, size and position of the person to be protected, different pressure conditions within the gas bag 2 may be advantageous. It therefore is known, cf. for example WO 2011/157 631 A1, to selectively control the internal pressure of the gas bag 2 during and/or after filling with gas from the gas generator 6. According to WO 2011/157 631 A1, e.g. an inflatable element, in particular in the form of a hose, can serve this purpose, to which inflatable element a gas source (different from the gas generator) is associated and which in the state filled with gas interacts with a vent opening of the airbag module in a defined way, in order to control the internal pressure of the gas bag. This can in particular be effected such that by filling the inflatable element with gas the outlet cross-section of the vent opening can be varied, e.g. in that the inflatable element in a defined way interacts with a covering member associated to the vent opening or itself forms such covering member. The vent opening can be provided at the gas bag itself.

For further details on the design and function of such device reference is made to WO 2011/157 631 A1, to which reference fully is made in this respect.

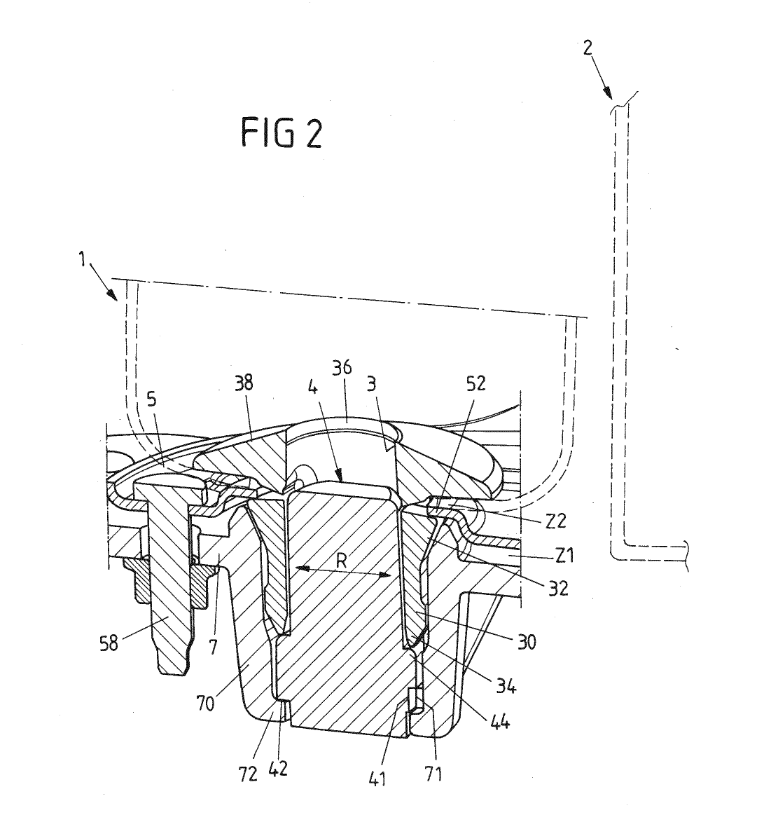

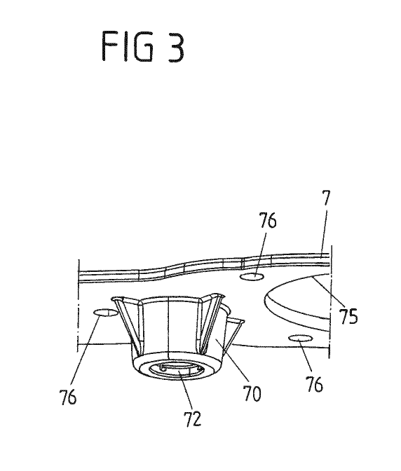

The further description above all relates to the arrangement and fixation of the inflatable element 1 and the associated triggering unit 4 at or in the airbag module, which will be explained below with reference to FIG. 1 and the detail representations according to FIGS. 2 and 3.

FIG. 2 shows a section of the airbag module of FIG. 1 in the region of the triggering unit 4 and an associated fixing element 3, wherein for better visibility of individual details the gas bag 2 and the inflatable element 1 are not shown here. And FIG. 3 shows a part of the module housing 7 of FIG. 1, concretely a section of the bottom region of that housing, on which the gas bag 2 and the gas generator 6 as well as the inflatable element 1 and the triggering unit 4 are arranged.

As can be seen in FIGS. 1 and 2, the triggering unit 4 is arranged within the module housing 7, so that it is surrounded by walls of the module housing 7. Concretely, the triggering unit 4 is located in a projection 70 of the module housing which protrudes from the main chamber of the module housing 7, in which the (folded) gas bag 2 is arranged and into which the gas generator 6 protrudes, which serves for inflating the gas bag 2.

The projection 70 of the module housing 7 is (axially) longitudinally extended and has a ring-shaped, in particular circular ring-shaped cross-section, so that the triggering unit 4 can axially be introduced into the projection 70. In the exemplary embodiment it is integrally molded to the wall of the main chamber of the module housing 7, more exactly to its bottom.

A defined (axial) positioning of the triggering unit 4 in the projection 70 of the module housing 7 is effected by stops 42, 72 associated to each other of the triggering unit 4 on the one hand and of the projection 70 on the other hand, via which the triggering unit 4 (axially) supports on the projection 70 of the module housing 7. (Flat) stops 41, 71 radially facing each other of the triggering unit 4 and of the projection 70 effect a (radial) positional fixation of the triggering unit 4.

A fixation of the triggering unit 4 secure against loss in the module housing 7 or in the exemplary embodiment more exactly in the projection 70 is achieved by a fixing element 3. The same protrudes into the projection 70 and with a base body 30 (hollow, ring-shaped in cross-section) reaches between the annularly extending wall of the projection 70 and the triggering unit 4 such that the triggering unit 4 can radially support on the base body 30 of the fixing element 3.

In the region of the module housing 7 or more exactly the bottom of the module housing 7, in which the projection 70 passes over into the main chamber of the module housing 7 accommodating the gas bag 2, the gas bag holder 5 which rests against the bottom of the module housing and in the exemplary embodiment is formed by a retaining plate includes an opening whose edge 52 is engaged behind by latching hooks 32 of the fixing element 3; in particular, a latching connection can exist here. The fixing element 3 thereby is locked in a position in which it holds the triggering unit 4 in the projection 70 of the module housing 7. For this purpose, a stop 34 is provided at the fixing element 3, which interacts with an associated stop 44 of the triggering unit 4, namely axially, and is located opposite the first stop pair 42, 72 of triggering unit 4 and projection 70.

Via the two stop pairs 34, 44 and 42, 72 the triggering unit 4 therefore is axially fixed in the projection 70 of the module housing 7. And vertically thereto (in radial direction) it is held by the annularly extending wall of the projection 70 and by the base body 30 of the fixing element 3, which protrudes into the projection 70.

The triggering unit 4 also has the tendency to expand on triggering the associated gas source (in radial direction R), whereby the latching hooks 32 are pushed to the outside and the latching effect even is increased.

Furthermore, a space Z1 between the module housing 7, more exactly its bottom, on the one hand and the gas bag holder 5 attached thereto on the other hand is indicated in FIG. 2. This space Z1 results from the fact that in FIG. 2 the gas bag to be arranged in the module housing 7 is not shown as well. In the case of a proper arrangement in the module housing 7, the gas bag 2 usually is clamped in the space Z1 in the region of its inflation opening between the housing bottom and the gas bag holder 5.

With reference to a synopsis of FIGS. 1 and 2 it can also clearly be seen that the triggering unit 4 counteracts unlocking of the fixing element 3, more exactly of the hooks 32 of the fixing element 3. For unlocking the fixing element 3, the latching hooks 32 engaging behind the edge 52 of the gas bag holder would have to be pressed together or pressed to the inside, which however is prevented by the triggering unit 4 whose outer wall forms a stop surface counteracting the pressing together of the latching hooks 32.

According to FIGS. 1 and 2, the fixing element 3 in addition has a head 38 which extends over the edge 52 of the opening in the gas bag holder 5. In a space Z2 formed between the head 38 of the fixing element 3 and the gas bag holder 5 the inflatable element 1 formed by a pressure hose therefore can positively and/or clampingly be fixed in the region of its inlet opening.

In the region of the head 38, the fixing element 3 defines an aperture 36 through which gas released by the triggering unit 4 can get into the inflatable element 1.

As a result, a single fixing element 3 thus serves both for fixing the triggering unit 4 in the module housing 7 or more exactly in a projection 70 of the module housing 7 and for fixation of the inflatable element 1 at the module housing, namely such that the same extends within the gas bag 2.

FIG. 3 reveals additional details of the bottom of the module housing 7, to which the projection 70 is integrally molded and against which the gas bag holder 5 rests, see also FIGS. 1 and 2.

Accordingly, the bottom of the module housing 7 includes a plurality of mounting openings 76, through which the module housing 7 is connectable with the gas bag holder 5, as is shown in FIGS. 1 and 2.

Furthermore, a large-surface cut-out 75 is provided, through which the gas generator 6 protrudes into the main chamber of the module housing 7, as is likewise shown in FIG. 1.

The inflatable element 1 arranged within the gas bag 2 according to the exemplary embodiment, alternatively can also be provided outside the gas bag 2, as indicated in FIG. 2 in broken lines.

1. An airbag module for a motor vehicle, comprising
a gas bag which for the protection of a person can be inflated by means of a gas generator,
a module housing for accommodating the gas bag, which includes a projection which protrudes from a main chamber of the module housing accommodating the gas bag,
a gas bag holder for fixing the gas bag at the module housing,
an inflatable element for regulating the gas pressure in the gas bag, which is fixed at the gas bag holder and which in the inflated condition is provided to interact with a vent opening through which gas originating from the airbag module can escape,
a triggering unit comprising a gas source for filling the inflatable element with gas, which is arranged within the module housing in the projection of the module housing, wherein the gas source is different from the gas generator, and
a fixing element by means of which the triggering unit is fixed at the module housing,
wherein the fixing element with a base body, with which it at least sectionally encloses the triggering unit, engages into the projection of the module housing.

2. The airbag module according to claim 1, wherein the triggering unit is arranged in a space defined by the walls of the module housing.

3. The airbag module according to claim 1, wherein the projection of the module housing has a boundary wall extending annularly in cross-section.

4. The airbag module according to claim 1, wherein the triggering unit is positively fixed at the module housing by means of the fixing element.

5. The airbag module according to claim 1, wherein the fixing element includes at least one latching hook with which it can be latched at the gas bag holder and/or the module housing.

6. The airbag module according to claim 5, wherein the at least one latching hook of the fixing element is prevented from unlatching by the triggering unit.

7. The airbag module according to claim 6, wherein during a deformation which would lead to unlatching the at least one latching hook of the fixing element gets in contact with a stop surface of the triggering unit, so that a further deformation and hence unlocking of the latching hook is counteracted.

8. The airbag module according to claim 1, wherein the fixing element includes an aperture through which gas released by the triggering unit can flow into the inflatable element.

9. The airbag module according to claim 1, wherein the triggering unit is held between the fixing element and a stop of the module housing.

10. The airbag module according to claim 9, wherein the stop is formed at the projection of the module housing.

11. The airbag module according to claim 1, wherein the inflatable element is designed as inflatable hose.

12. The airbag module according to claim 1, wherein the inflatable element is arranged within the gas bag.

13. The airbag module according to claim 1, wherein at the fixing element additionally serves for fixing the inflatable element at the gas bag holder.

14. The airbag module according to claim 13, wherein the inflatable element is clamped between a head of the fixing element and the gas bag holder.

15. (canceled)

16. (canceled)

17. The airbag module according to claim 1, wherein the outlet cross-section of the vent opening is increased or reduced by filling the inflatable element with gas.
